(19) United States
(12) Patent Application Publication
(10) Pub. No.: US 2017/0155893 A1
(43) Pub. Date: Jun. 1, 2017

(54) VARIABLE BARRIER PITCH CORRECTION

(71) Applicant: Sharp Kabushiki Kaisha, Osaka (JP)

(72) Inventors: Jonathan MATHER, Oxford (GB); Laura HUANG, Oxford (GB); Alexander ZAWADZKI, Oxford (GB); Forrest BRENNEN, Oxford (GB)

(21) Appl. No.: 15/320,605

(22) PCT Filed: Jun. 25, 2015
(86) PCT No.: PCT/JP2015/003206

§ 371 Date: Dec. 20, 2016

(30) Foreign Application Priority Data
Jun. 25, 2014 (GB) 1411280.9

(51) Int. Cl. H04N 13/04

(52) U.S. Cl. CPC H04N 13/0409; H04N 13/0477; H04N 13/0497

(57) ABSTRACT

Two methods are described for calculating the non-periodic display pixel pattern necessary for good viewing properties of a multiple view directional display with a fixed parallax barrier pitch. These methods could also be used to calculate optimum barrier pitch parameters for a display with a re-configurable parallax optic, such as a re-configurable parallax barrier, and a fixed pixel assignment, or to calculate hybrid system parameters in a display where the parallax optic (eg a parallax barrier) and the pixel assignment are both re-configurable. The first method uses a geometrical analysis to calculate a non-integer subpixel repeat unit for interlacing. In this approach interlacing starts at a point determined by the user's head position relative to the display. The non-integer number ensures that the interlace pattern inserts extra pixels where necessary in order to compensate for the user's head position. The second method uses a pixel-by-pixel calculation step, whereby every pixel's position relative to the user's eyes and the nearest slit of the barrier determines whether the pixel should show left-view or right-view information. This approach may be done for blocks of pixels, but performance is optimal when calculated on a pixel-by-pixel basis.

### TECHNICAL FIELD

This invention relates to a multiple view directional display such as an autostereoscopic (glasses-free) 3D system that can maintain a 3D effect as a user moves closer to or further from the display. The invention is compatible with parallax barrier and lenticular lens systems. The invention could be used in other applications, for example to display different 2D content to multiple different users in the manner of commercial ‘Dual View’ displays.

### BACKGROUND ART

For many years people have been trying to create better autostereoscopic 3D displays, and this invention provides a further advance in this field. An autostereoscopic display is a display that gives stereoscopic depth without the user needing to wear glasses. This is accomplished by projecting a different image to each eye. An autostereoscopic 3D display can be realised by using parallax optic technology such as a parallax barrier or lenticular lenses.

The design and operation of parallax barrier technology for viewing 3D images is well described in a paper from the University of Tokushima Japan (“Optimum parameters and viewing areas of stereoscopic full colour LED display using parallax barrier”, Hirotsugu Yamamoto et al., IEICE trans electron, vol E83-c no 10 Oct. 2000).

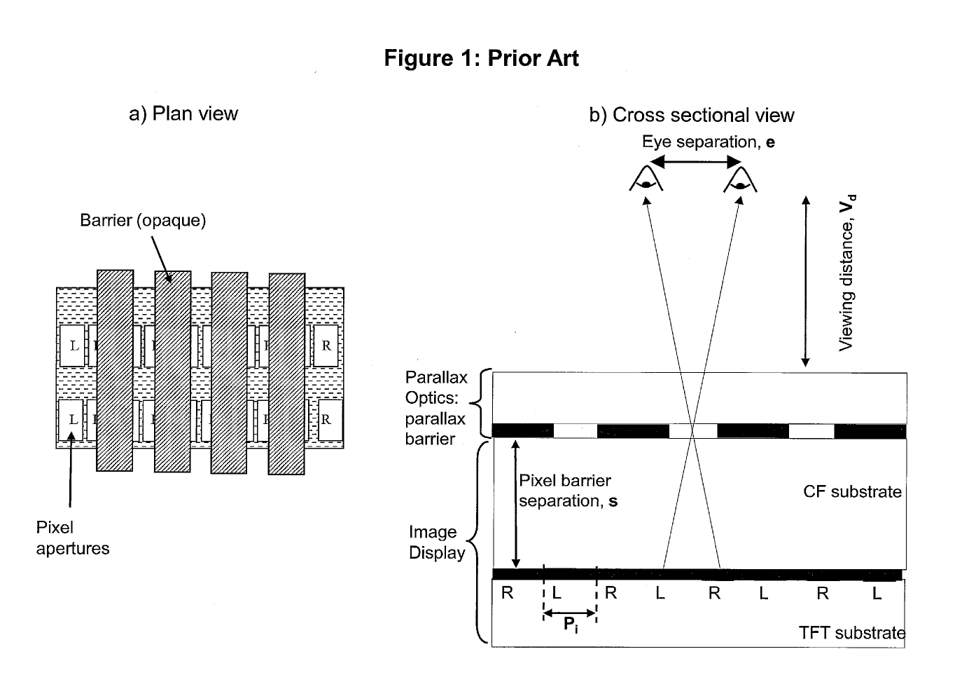

FIG. 1 shows the basic design and operation of parallax barrier technology for use in conjunction with an image display for creating a 3D display. The images for the left eye and right eye are interlaced on alternate columns of pixels of the image display. The slits in the parallax barrier allow the viewer to see only left image pixels from the position of their left eye and right image pixels from the position of their right eye.

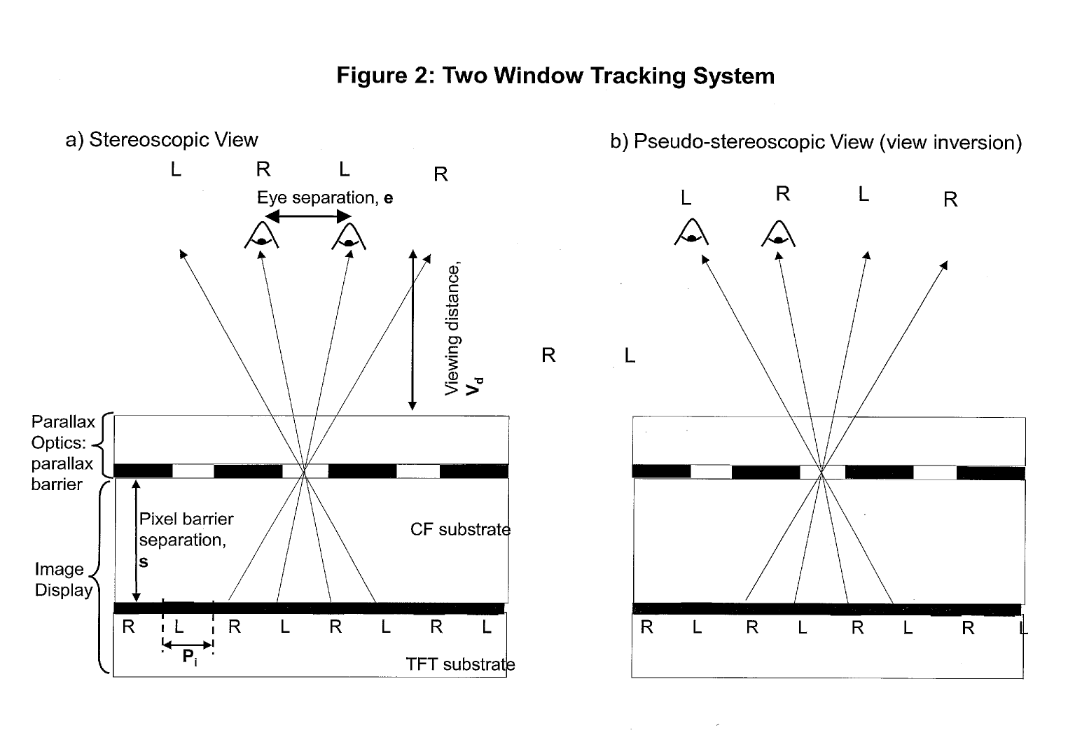

A fixed parallax barrier or lens system has the disadvantage that the viewer observes a stereoscopic image only in strict viewing zones. Outside these zones, pixel information intended for the left eye may reach the right eye and vice versa. FIG. 2 (a) shows how the user can see the correct image, and FIG. 2 (b) shows the result of the user moving their head laterally (while keeping at the same distance from the display) is that the user sees a pseudoscopic image where each eye sees light from the wrong pixel regions.

By tracking the positions of the user's eyes, the system can be adjusted in order to change the size and position of the viewing zones. These improvements can be achieved by changing the pixel values, or by changing the barrier parameters or a combination of both.

Mechanical tracking involves physically moving the parallax barrier or optics relative to the pixels and the screen. U.S. Pat. No. 6,377,295 and U.S. Pat. No. 5,083,199 describe how this might be achieved with a lenticular lens system and a parallax barrier system respectively. The authors of U.S. Pat. No. 6,377,295 note that mechanical tracking has drawbacks. Adding a mechanical element to the system is likely to increase the total system cost, whilst the dependence on moving parts could decrease the system robustness. Another concern is that the tracking speed of a mechanical system may not be fast enough to cope with rapid changes in user position.

Electrical tracking, such as discussed in EP0860729-B1, may be achieved by using a parallax barrier composed from a liquid crystal, and electrically addressing it in order to spatially change its transmission properties. Such a barrier has certain advantages: it involves no moving parts, and it may be switched into a transmissive state in order to give a full resolution 2D mode. This approach is not without drawbacks: making a high quality switchable LC barrier is technically very challenging. The shutter must be controllable on a scale smaller than the display's pixels, which is technically complex. The shutter should not include any opaque features which might cause Moire problems with the underlying display. Discrete switching of an electronic barrier causes problems with the brightness uniformity of the resulting image.

Tracking pixel values underneath a stationary lens or barrier offers some attractive advantages over tracking barrier designs. Since a tracking barrier is not required the system may be simpler and cheaper—a printed parallax barrier of transmissive and opaque features can be used instead of an expensive and complex optical tracking system. The tracking speed of the system depends significantly on the speed of the image display, but mobile displays designed for video content already run at fast frame rates. Tracked pixel systems can be scaled up to large display sizes much more easily than tracked barrier type displays can be.

An early tracked pixel 3D display was disclosed by K Akiyama and N Tetsutani, “3-Dimensional Visual Communication”, ITEC'91, 1991 OTE Annual Convention. In this design, a lenticular lens sheet angularly multiplexes light from adjacent columns of pixels on a display. A position detector monitors the user's position, causing the display to switch the information displayed on the columns of pixels when the user moves out from the primary viewing window. This system greatly increases head freedom, but introduces a very visible artefact when users switch between viewing windows.

An improved system was disclosed by U.S. Pat. No. 5,959,664, whereby the image display contains right eye data, left eye data and some regions which are not seen by either eye. These redundant regions are extremely important, since they allow for increased tolerance to movement of the observer towards or away from the display (“Z-tolerance”) and smoother tracking. Instead of performing a visible left/right image data swap, the appropriate image data can be loaded into a region not yet visible to the observer. When the observer's head moves laterally the correct view information may then be seen, allowing for smooth tracking.

Even with these developments, current head tracking 3D technologies are far from perfect. In particular, adjusting for movements of the user towards or away from the display remains a major unsolved problem.

### SUMMARY OF INVENTION

As explained with reference to FIG. 2, movement of the observer relative to the display in a lateral direction, while maintaining the same separation between the observer and the display, will cause the observer to move from a position at which they perceive a 3-D image to a position at which they do not perceive a 3-D image. However, the spatial regions in which a left eye image or a right eye image is displayed also have a finite extent in the direction perpendicular to the display (this will be taken to be the z-direction). A conventional autostereoscopic display thus has a designed viewing distance, such that an observer perceives the best 3-D effect when they are at the designed viewing distance—and if the observer moves closer to, or moves further away from, the display the 3-D image quality is degraded. When an autostereoscopic display is intended for use in situations where the distance between an observer and the display may vary, it is therefore desirable to track movement of the observer towards or away from the display (“z-tracking”) instead of, or in addition to, tracking lateral movement of the observer with respect to the display.

In a display that uses z-tracking, if it is determined that the distance between the observer and the display has changed significantly the optimum viewing distance of the display may then be changed, so as to be made equal or substantially equal to the current distance between the display and the observer. This ensures that the observer perceives a high quality 3-D image even though the separation between the observer and the display does not stay constant. In order to adjust the optimum viewing distance of a parallax type 3D display, either the barrier pitch must be changed, or the positions (relative to the barrier) of images on the display pixels must be changed by re-assigning the pixel values (that is, re-assigning the data value supplied to the pixels of the display), or some hybrid solution must be used. In a case where the display has a fixed barrier, the optimum viewing distance must be adjusted through a re-assignment of the pixel values.

The inventors have recently developed a new tracking system suitable for high quality z-tracking. They have developed two methods for calculating the correct display pixel pattern that allows a non-integer pixel interlace value to be mapped to an integer number of pixels to obtain good viewing properties when using a fixed barrier pitch display. These methods could also be used to calculate optimum barrier pitch parameters in a case where the barrier is reconfigurable and the pixel assignment is fixed, or to calculate hybrid system parameters in a case where the barrier and the pixel assignment are both reconfigurable.

Approach 1: use a geometrical analysis to calculate a non-integer subpixel repeat unit for interlacing. In this approach interlacing starts at a point determined by the user's head position relative to the display. The non-integer number ensures that the interlace pattern inserts extra pixels where necessary in order to compensate for the user's head position. The use of a non-integer interlacing pattern has not been previously reported.

Approach 2: use a pixel-by-pixel calculation step, whereby every pixel's position relative to the user's eyes and the nearest slit of the barrier determines whether the pixel should show left-view or right-view information. This approach may be done for blocks of pixels, but performance is optimal when calculated on a pixel-by-pixel basis.

With small adjustments, these approaches can also be used to calculate parameter values for tracked barrier systems, or hybrid tracked pixel and barrier systems.

A first aspect of the invention provides a method of displaying a multiple view image comprising: for a group of n pixels (n=1, 2, 3 . . . ) of an multiple view directional display, determining, based on the distance between the display and an observer, where a ray path from the group of pixels to the observer intersects a parallax optic of the display; determining, from the intersection of the ray path and the parallax optic, whether the group of pixels should display a first image or a second image; and assigning data values to the or each pixel of the group according to the determination whether the group of pixels should be addressed with data relating to the first image or with data relating to the second image.

The first aspect of the invention may for example be applied with a fixed (that is, non-reconfigurable) parallax optic, to determine pixels that should display the first image and to determine pixels that should display the second image (for example to determine pixels that should display a left eye image and to determine pixels that should display a right eye image, to provide a 3-D autostereoscopic image to the observer). This aspect may be used to implement z-tracking, by, as the observer moves towards or away from the barrier, recalculating which pixels should display the left eye image and which pixels should display the right eye image and re-addressing the image display layer accordingly so that the observer continues to see a good-quality 3-D image.

A second aspect of the invention provides a method of displaying a multiple view image comprising: for a group of n pixels (n=1, 2, 3 . . . ) of a multiple view directional display, determining, based on the distance between the display and an observer, where a ray path from the group of pixels to the observer intersects a re-configurable parallax optic of the display; determining, from the intersection of the ray path and the parallax optic, a desired location and size for one or more elements of the parallax optic; and addressing the parallax optic to define one or more elements in the parallax optic in accordance with the determined location and size. For example, where the parallax optic comprises a parallax barrier array the method may comprise determining a desired location and size for one or more opaque barrier regions of the parallax optic. This method is generally complementary to the first aspect, but may be applied to a display having a reconfigurable parallax optic to determine a configuration for the parallax optic of the display based on the distance between the display and the observer. This aspect may be used to implement z-tracking, by, as the observer moves towards or away from the barrier, reconfiguring the parallax optic so that the observer continues to see a good-quality 3-D image. By a “re-configurable” parallax optic is meant that the parallax optic may be re-configured to vary the position and/or size of the elements of the parallax optic. One example of a re-configurable parallax optic is a parallax barrier embodied as a liquid crystal panel, when the position and/or size of the opaque and transmissive regions of the parallax barrier may be varied by suitably addressing the liquid crystal panel.

A third aspect of the invention provides method of displaying a multiple view image comprising: determining, based on the distance of an observer from a multiple view directional display having an image display layer and a parallax optic, the width of a projection of an element of the parallax optic onto the image display layer; determining a pixel interlace value from the width of the projection of the element of the parallax optic onto the image display layer; and assigning a pixel with data corresponding to a first image or with data corresponding to a second image in accordance with the determined pixel interlace value.

The third aspect of the invention may for example be applied with a fixed (that is, non-reconfigurable) parallax optic, to determine a pixel interlace value based on the distance of the observer from the display pixels and addressing the image display layer to obtain the calculated pixel interlace value or a value close thereto. This aspect may be used to implement z-tracking, by, as the observer moves towards or away from the barrier, recalculating the pixel interlace value and addressing the image display layer to obtain the recalculated pixel interlace value, or a value close thereto, so that the observer continues to see a good-quality 3-D image.

A fourth aspect of the invention provides a method of displaying a multiple view image comprising: determining a desired projection of an element of a re-configurable parallax optic of a multiple view directional display having an image display layer and the parallax optic based on a desired pixel interlace value; determining a desired size for the element of the parallax optic, from the desired projection of the element; and addressing the parallax optic to obtain an element of the desired size.

The fourth aspect is generally complementary to the third aspect, but may be applied to a display having a reconfigurable parallax optic to determine a configuration for the parallax optic of the display based on the distance between the display and the observer. This aspect may be used to implement z-tracking, by, as the observer moves towards or away from the barrier, reconfiguring the parallax optic so that the observer continues to see a good-quality 3-D image.

A method of the first or third aspect may be applied with a multiple view directional display having any form of parallax optic, such as, for example, a parallax barrier aperture array or a lenticular parallax optic. A method of the second or fourth aspect may be applied with a multiple view directional display having any form of re-configurable parallax optic, such as, for example, a re-configurable parallax barrier aperture array.

A fifth aspect of the invention provides a multiple view directional display configured to perform a method of the first, second or third aspect.

A sixth aspect of the invention provides a multiple view directional display comprising: an image display panel; a parallax optic; an observer tracking unit; and a control unit, the control unit adapted to perform a method of the first, second, third or fourth aspect.

A seventh aspect of the invention provides a multiple view directional display comprising: an image display panel; a parallax optic; an observer tracking unit; and a control unit, the control unit adapted to assign data values to pixels of the image display panel such as to provide an interlacing pattern of a first image and a second image having a repeat length that is a non-integer number of pixels. Use of a non-integer NP interlace value makes it possible to provide good image quality even if the observer(s) move away from, or closer to, the display.

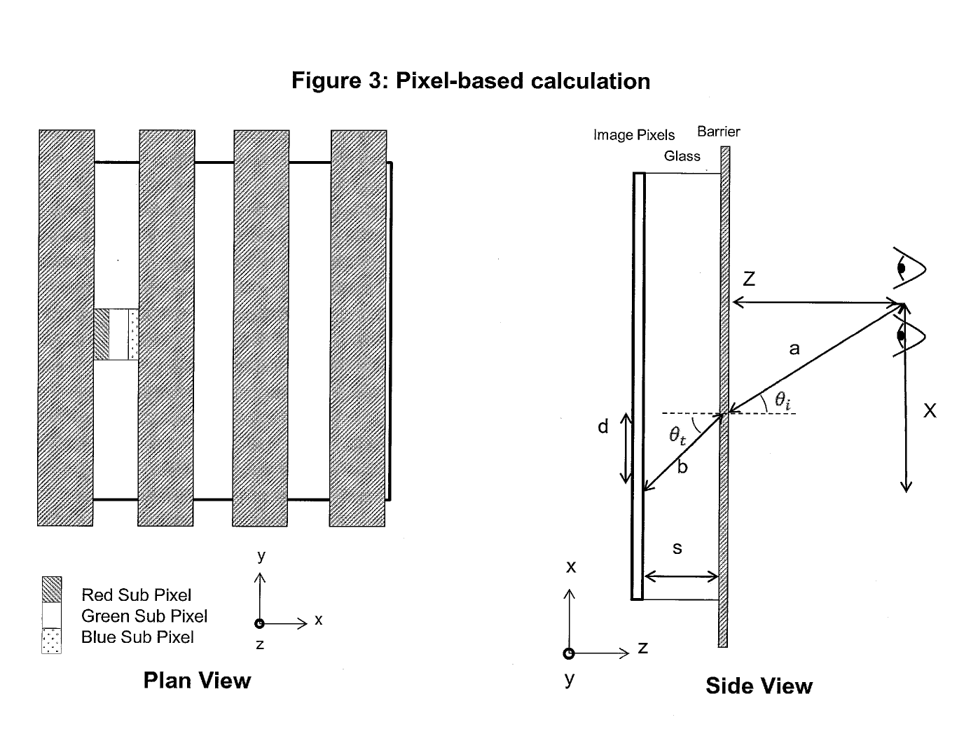

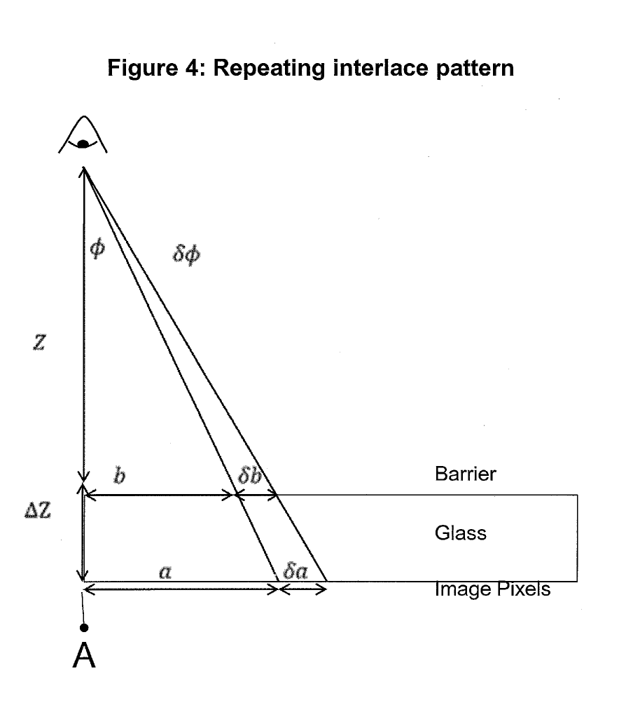

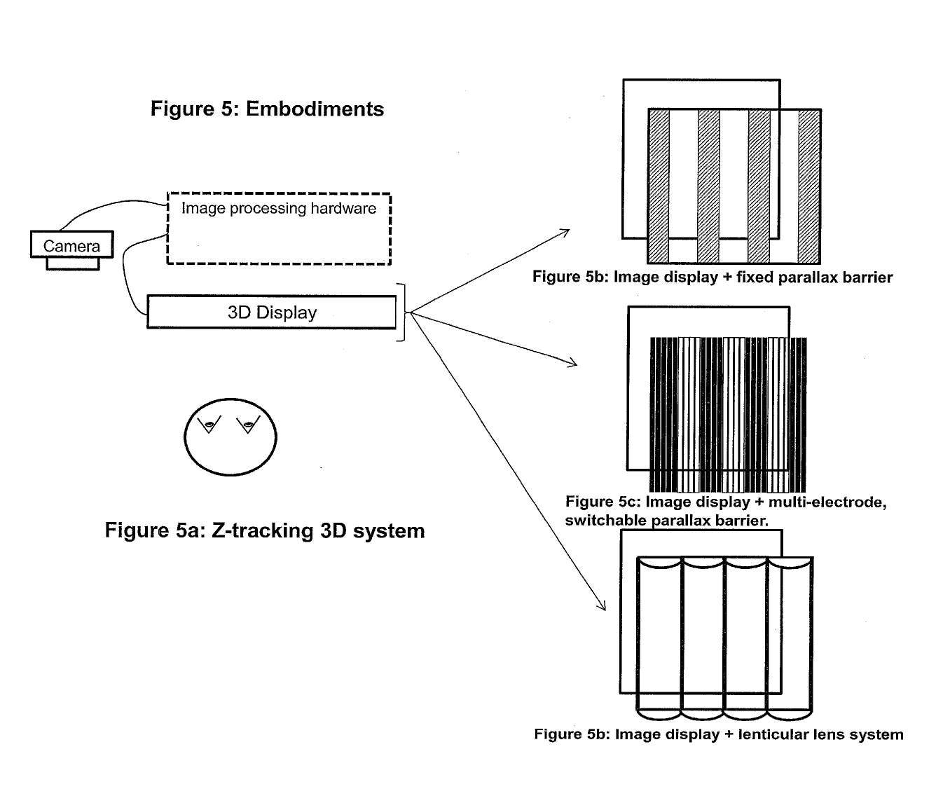

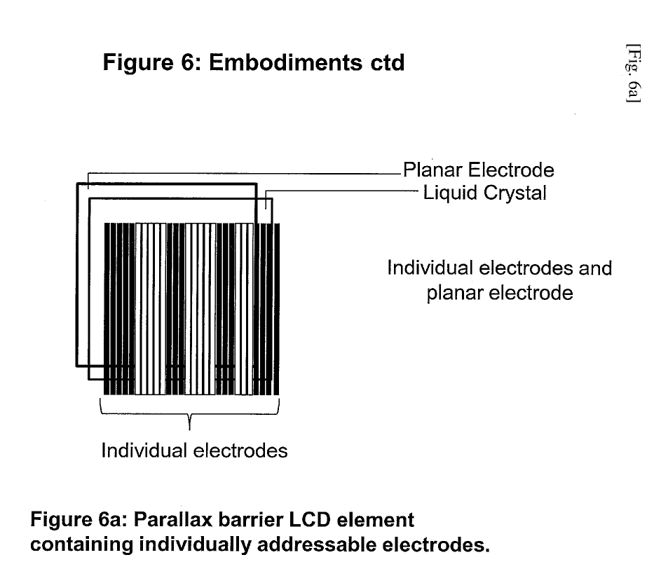

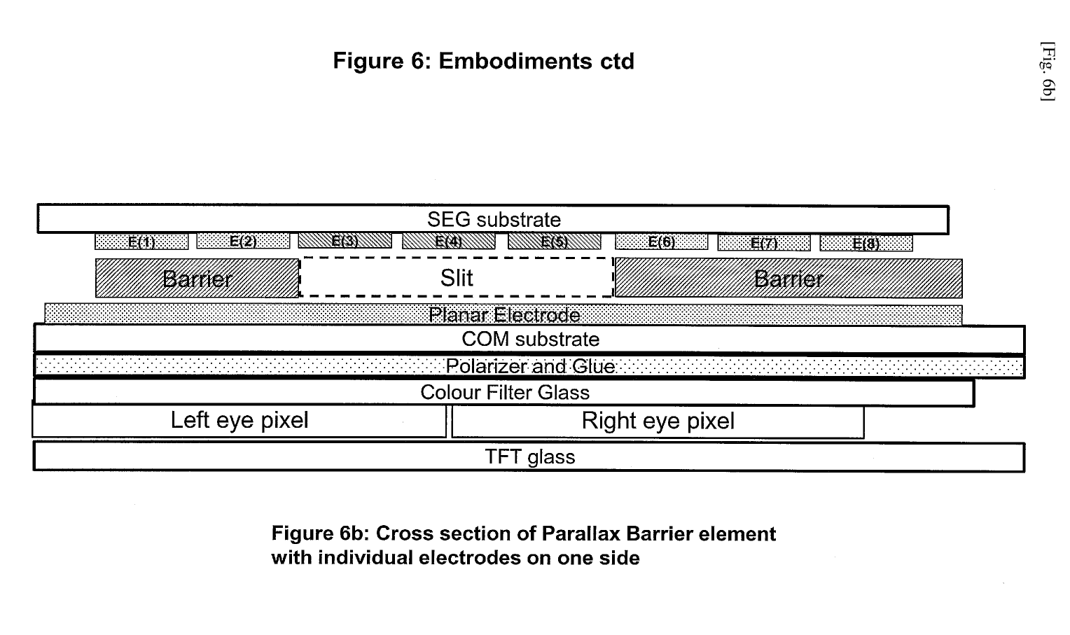

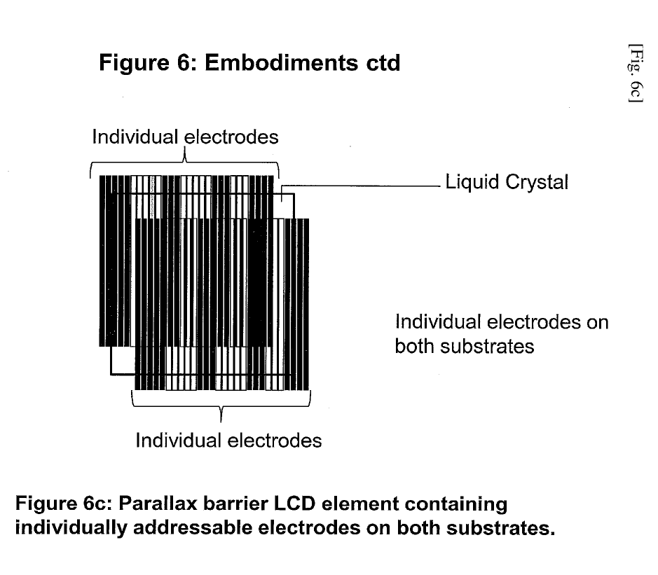

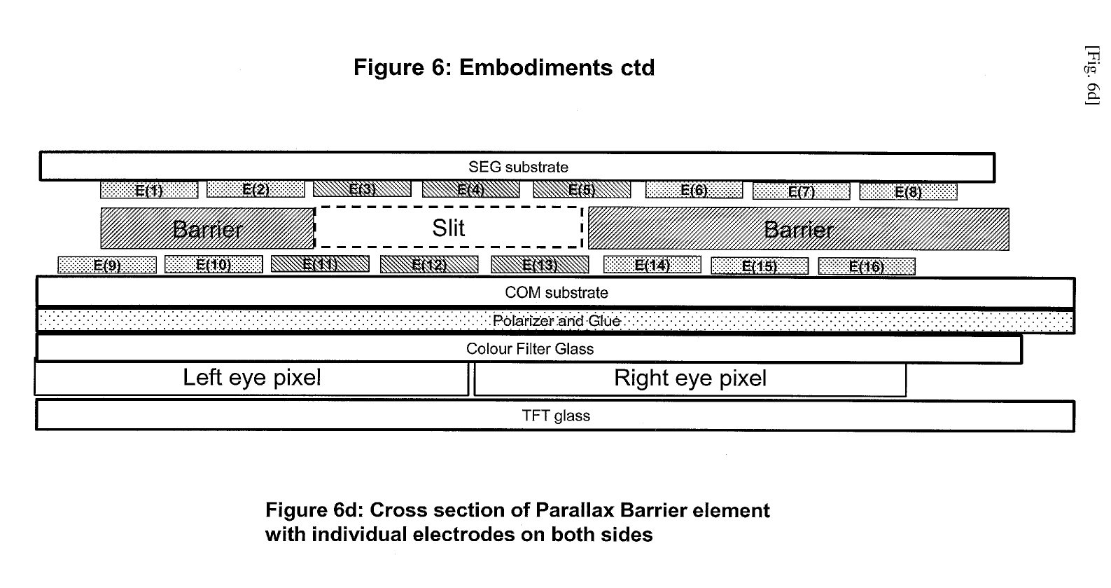

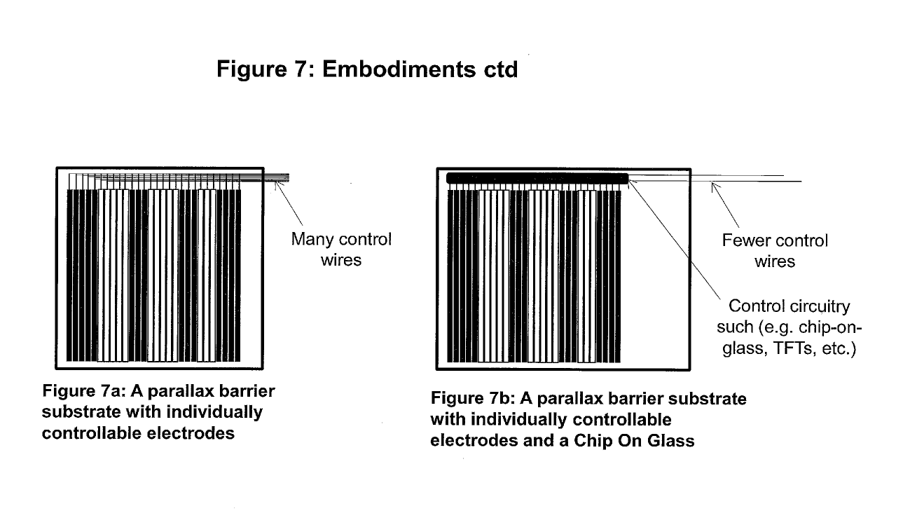

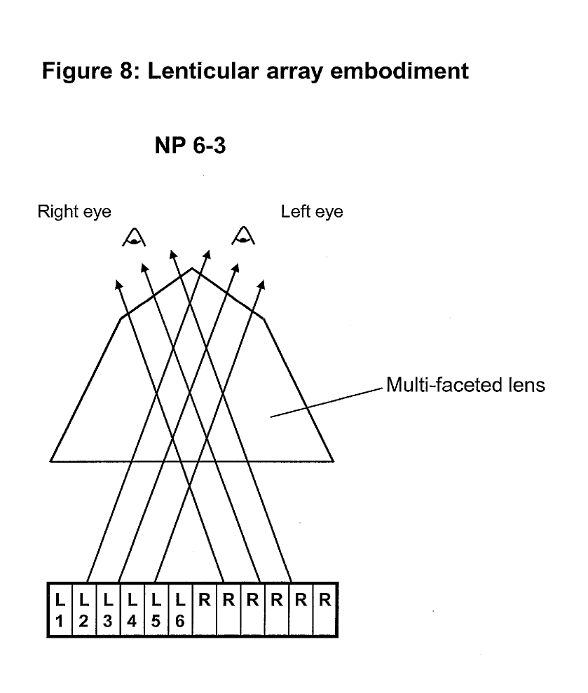

### BRIEF DESCRIPTION OF DRAWINGS

[FIG.1a] Prior Art, plan view of fixed parallax barrier display

[FIG.1b] Prior Art, cross sectional view of fixed parallax barrier display

[FIG.2a] Two Window Tracking System, correct on-axis stereoscopic view

[FIG.2b] Two Window Tracking System, inverted off-axis pseudo-stereoscopic view

[FIG.3] Pixel-based calculation

[FIG.4] Repeating interlace pattern

[FIG.5a] Embodiments, z-tracking 3D system outline

[FIG.5b] Embodiments, image display and fixed parallax barrier

[FIG.5c] Embodiments, image display and multi-electrode switchable parallax barrier

[FIG.5d] Embodiments, image display and lenticular lens system

[FIG.6a] Embodiments, Parallax barrier LCD element containing individually addressable electrodes

[FIG.6b] Embodiments, cross section of parallax barrier element with individual electrodes on one side

[FIG.6c] Embodiments, parallax barrier LCD element containing individually addressable electrodes on both substrates

[FIG.6d] Embodiments, cross section of parallax barrier element with individual electrodes on both sides

[FIG.7a] Embodiments, parallax barrier substrate with individually controllable electrodes

[FIG.7b] Embodiments, parallax barrier substrate with individually controllable electrodes and a chip on glass

[FIG.8] Lenticular array embodiment, NP 6-3 system

### DESCRIPTION OF EMBODIMENTS

The motivation for tracking is to know the position of the user's left and right eyes. This information can then be used to display image data, and/or change the optical properties of the system, such that each eye is shown a different image and the user experiences stereoscopic 3D even though the user is moving relative to the display. The inventors have developed two new methods for calculating positions of optical elements in the display relative to the user and appropriately updating the display system. The invention may be used to calculate the pixel affinity (that is, whether a pixel or sub-pixel should display a left eye image or a right eye image) of one or more pixels or sub-pixels in a display having a parallax optic of known configuration, and in this case the display system may be updated by re-assigning pixel values dependent on determined pixel affinity. Additionally or alternatively, the invention may be used to calculate the positions of elements of the parallax optic (such as the positions of opaque regions of a parallax barrier aperture array) in a display in which the parallax optic can be reconfigured to track the position of an observers moving relative to the display, and/or calculating positions of barrier regions of a parallax barrier in this case the display system may be updated by re-configuring the parallax optic.

The first method involves tracing a light ray from each image pixel (or form a block of pixels) to the user's mid-eye position. This light ray intercepts the parallax barrier, or other optical element, at a certain position. The distance between this intercept point and the nearest slit on the barrier is determined from the relative positions of the user and display, and from one or more parameters of the display such as refractive indices. In one example the one or more parameters of the display comprise a separation between an image display layer of the display and the parallax optic and the ratio between the refractive index of a medium between the image display layer of the display and the parallax optic and the refractive index of a medium between the display and the observer. The distance between the intercept point and the closest slit determines whether the light ray, and hence the pixel, is seen by the left or right eye.

If the pixel is to be seen by a left eye then it can be loaded with a perspective image suitable for the left eye. If these perspective images are pre-rendered, then the pixel can ‘look up’ the appropriate image data, that is a pre-rendered data value is assigned to the pixel. The process for right eye data is identical.

Depending on the barrier design, there may be ‘redundant’ regions of pixels which are not seen by either eye. This interlacing method causes them to be loaded with the most appropriate image data and hence allows for smooth tracking. As the user moves, the pre-loaded data becomes visible without any image updating latency or brightness variation.

By running the geometrical calculations as a GPU accelerated shader it is possible to calculate large numbers of pixel affinities in real time.

FIG. 3 illustrates how a pixel affinity (that is, whether a pixel should display a left eye image or a right eye image) can be derived from geometric terms. For example the pixel affinity may be derived based on the distance between, on the one hand, the intersection of the ray path (from the pixel to the observer) and the parallax optic and, on the other hand, the nearest aperture of the parallax optic.

FIG. 3(a) is a front plan view of a display, and FIG. 3(b) is a schematic sectional view of the display showing a parallax barrier separated from a pixelated image display layer by a substrate (in this example a glass substrate).

As indicated in FIG. 3, the display face of the display is assumed to be in the x-y plane, so that the z-axis extends perpendicularly to the display face of the display. For the sake of example the x-axis is shown extending horizontally in FIG. 3(a) and the y-axis is shown extending vertically in FIG. 3(a). A viewer is positioned such that their mid-eye position is at a distance Z from the front face of the display, and has an x-co-ordinate denoted by X. As a simplification, it is assumed here that the viewer's mid-eye position, image pixels and the barrier intercept (a “barrier intercept” is a point where a ray from a pixel to the viewer's mid-eye position intercepts the plane of the barrier) are all in the same y-plane, and so y-coordinate terms can be omitted.

In FIG. 3(b), the separation in the z-direction between the image display layer and the barrier is denoted by s, and the separation in the x-direction between a pixel and its corresponding barrier intercept is denoted by d.

$$α = \frac{sin {θ}_{i}}{sin {θ}_{t}} = \frac{{n}_{glass}}{{n}_{air}}$$

$${a}^{2} = {( X - d )}^{2} + {Z}^{2} \approx {X}^{2} + {Z}^{2}$$

$${b}^{2} = {d}^{2} + {s}^{2}$$

Given Z and X, we can then compute d.

$$α = \frac{sin {θ}_{i}}{sin {θ}_{t}} = \frac{xb}{ad}$$

$${α}^{2} {a}^{2} {d}^{2} = {X}^{2} {b}^{2}$$

$${d}^{2} ( {α}^{2} ( {X}^{2} + {Z}^{2} ) - X ) = {X}^{2} {s}^{2}$$

$$d = \frac{X s}{\sqrt{{α}^{2} ( {X}^{2} + {Z}^{2} ) - {X}^{2}}}$$

$$d = \frac{X s}{\sqrt{{α}^{2} {X}^{2} + {α}^{2} {Z}^{2} - {X}^{2}}} \approx \frac{X s}{α Z}$$

Thus, given a pixel co-ordinate (pₓ,p_{y}) and a user mid-eye position (eₓ,e_{y}) the barrier intercept coordinates (bₓ,b_{y}) for a ray from the pixel to the user can be found as:

$${b}_{x} = {p}_{x} + d$$

$$where d = \frac{X s}{Z α} = \frac{( {e}_{x} - {p}_{x} ) s}{Z α}$$

$$giving \text{:} {b}_{x} = {p}_{x} + \frac{( {e}_{x} - {p}_{x} ) s}{Z α}$$

That is, the x-co-ordinate of the barrier intercept may be determined from the x-co-ordinates of the user's mid-eye position and the pixel, the distance Z between the observer and the front face of the display, and fixed properties of the display (namely the ratio α between the refractive index of the glass substrate and the medium between the display and the observer (typically air), and the thickness s of the glass substrate).

Once the barrier intercept co-ordinates are known, the closest barrier slit to the barrier intercept can be found, and this determines whether the pixel will be seen by the left eye or right eye of the observer. Determining the closest barrier slit to the barrier intercept, may be done by determining χ according to:

$$\frac{{b}_{x} - nearest slit to the left}{barrier pitch} = χ$$

If χ is less than 0.5 then the pixel is closer to being seen by the left eye, otherwise the pixel is closer to being seen by the right eye.

Left-eye or right-eye image data may then be assigned to the pixel, in accordance with the determination whether the pixel is closer to being seen by the left eye or the right eye.

The above description refers to calculating the barrier intercept for a ray from a single pixel (this may be considered as a group of 1 pixel, ie n=1) to the user. However, the invention may alternatively be used to calculate the barrier intercept for a ray from a group of two or more pixels (ie n>1) to the user—this will reduce the required computation, but at the expense of a reduction in perceived 3-D image quality.

The above description refers to calculating the barrier intercept on the assumption that the y-co-ordinates are the same. The invention does not however require this, and may be extended to the case where the pixel, the user and the barrier intersect do not have the same y-co-ordinates as one another.

The second method involves calculating a non-integer interlace value, and using that to determine the eye affinity of pixels on the display. With reference to FIG. 4, if δb is the pitch of the parallax barrier (the “pitch” is the repeat distance, ie the sum of the width of an aperture of the barrier and the width of an opaque region of the barrier) then δa, which is the projection of the pitch of the parallax barrier onto the plane of the pixels of the display should preferably be arranged to be an exact integer repeat unit in pixels to give the user a high-quality 3-D effect. If the 3D system is designed with an NP2 interlace, then the display is conventionally configured such that δa is an exact integer repeat unit in pixels when the user is at the designed viewing distance. However, when the viewer moves in Z then the original interlacing pattern soon fails to provide a good-quality 3-D image, since the relationship between δa and δb changes as Z changes. (The naming convention used for interlacing patterns is based upon that used in “Development of Dual View Displays”, (Mather, 2007). For a NPX-Y system ‘X’ denotes the repeat unit size and ‘Y’ denotes the width of the barrier slit. A NP1 system has the pattern LRLR . . . where L is a pixel or sub-pixel with Left view data and R is a pixel or sub-pixel with Right view data. An NP2 system is LLRRLLRR . . . )

The inventors have realised that, if the interlace repeat distance is set such that

$$( repeat ) = \frac{δ a}{2 \times pixel pitch} ,$$

where “pixel pitch” is the pitch of pixels of the image display panel, and if the interlace fill is done from the position on the display closest to the viewer, then the displayed image will be correct for the viewer over a much greater range of distances between the observer and the display.

The quantity δa is dependent on the distance Z between the observer and the display, so that calculating n(repeat) in this way is likely to lead to a non-integer result. Pixels are then assigned to the left eye image or to the right eye image so as to obtain a pixel repeat distance that is equal to, or is close to, the determined value of n(repeat). For example assigning pixels as: LLRRLLLRR rather than LLRRLLRR would lead to an effective value of n(repeat) of 9/4, whereas assigning pixels as: LLRRLRR rather than LLRRLLRR would lead to an effective value of n(repeat) of 7/4. As noted, the starting point for the interlace fill is the position on the display closest to the viewer (point A in FIG. 4).

In the case of an effective value of n(repeat) of 9/4, the pixel assignment may be calculated as follows:

(9/4)→rounds to 2, so display 2 pixels as L;

(9/4+9/4=9/2)→rounds to 4, so display another (4−2=2) pixels as R;

(9/4+9/4+9/4=27/4)→rounds to 7, so display another (7−4=3) pixels as L;

(9/4+9/4+9/4+9/4=9), so display (9−7=2) pixels as R.

The pixel assignment for any other effective value of n(repeat) can be calculated in an analogous way.

The interlace fill is preferably done symmetrically, starting at the point in the display that is the closest point on the display to the viewer (point A in FIG. 4), and working outwards horizontally in both directions from this starting point. (This assumes that the closest point is not at an edge of the display—if the closest point is at an edge of the display the interlace fill is necessarily done working in one direction only—that is, the interlace fill is not done symmetrically.

If the user were to move laterally with respect to the display the pixels would need to be re-assigned between the left eye image and the right-eye image to ensure that the user continued to perceive a good quality 3-D image—the pixel reassignment would be done keeping the same interlace repeat, but starting the fill at the position on the display closest to the viewer's new location.

The invention is not limited to a display having a parallax barrier as the parallax optic. A variation of the second method may be applied to a display in which the parallax optic comprises a lenticular array, for example as seen in U.S.20120229896 (“Lenticular array intended for an autostereoscopic system”). It should be understood that the term “lenticular array” as used herein is intended to cover an array of multiple faceted (or “prismatic”) lenticular elements, as well as an array of lenticular elements with continuously curved lenticular faces. For the purposes of this invention such a lenticular array is functionally equivalent to a parallax barrier system. For example a parallax optic formed of an array of multiple faceted lenticular elements is functionally equivalent to an NPX-Y parallax barrier system when each lenticular lens is designed to have a width, parallel to the image display panel, equal or substantially equal to 2X adjacent columns of pixels or sub-pixels, and when each facet of the lenticular array is designed to have a width of Y pixels or sub-pixels. (In many cases the pitch of the parallax optic is preferably not set to be precisely equal to 2× or two sets of eye-(sub-)pixels, but is adjusted slightly from this value to account for viewing angle—for example when the parallax optic is above the image display plane, the pitch of the parallax optic is preferably set to slightly less than two eye-(sub-)pixels.) The second method described above may be used to calculate an interlace value and pixel affinity for such a display exactly as if the parallax optic is an NPX-Y parallax barrier system. In this case, the pitch δb of the parallax optic is the repeat distance of one lenticular lens (the principle is that one “pitch” of a parallax barrier substantially covers one complete set of left eye sub-pixels and right eye sub-pixels, and similarly one “pitch” of a lenticular parallax optic substantially covers one complete set of left eye sub-pixels and right eye sub-pixels with one lenticular lens). The term δa is the projection of the pitch of the lenticular parallax optic onto the plane of the pixels of the display. The desired repeat distance may thus be determined as

$$n ( repeat ) = \frac{δ a}{2 \times pixel pitch } ,$$

in the same manner described above for a parallax barrier.

FIG. 8 illustrates an NP6-3 system where an element of the parallax optic comprises a multi-faceted lens, with the lens configured such that a first set of sub-pixels (or pixels) with a width of 3 columns of sub-pixels (or pixels) is visible to the viewer's left eye, while a second set of sub-pixels (or pixels), which is different to the first set, with a width of 3 columns of sub-pixels (or pixels) is visible to a viewer's right eye. It should be noted that the first [second] set of sub-pixels (or pixels) visible to the viewer's left [right] eye may comprise 3 or 4 sub-pixels (or pixels) but the region of the pixelated display visible to the viewer's left [right] eye always has a width equal to 3 sub-pixels (or pixels), With reference to FIG. 8, assume that for a first given observers head position the left eye image is addressed to the first 6 sub-pixels (or pixels) shown in FIG. 8 (labelled 1 to 6) and the right eye image is addressed to the next 6 sub-pixels (or pixels). Also assume that, for this observer head position, sub-pixel (or pixel) 1 is not visible to the viewer, half of sub-pixel (or pixel) 2 is visible to the viewer's left eye 21, all of sub-pixel (or pixel) 3 is visible to the viewer's left eye 21, all of sub-pixel (or pixel) 4 is visible is the viewer's left eye 21, half of sub-pixel (or pixel) 5 is visible to the viewer's left eye 21 and sub-pixel (or pixel) 6 is not visible to the viewer. Consequently, for this first given head position, 4 sub-pixels (or pixels) are visible to the viewer (L2, L3, L4 and L5) but the width of the display visible to the viewer's left eye is exactly 3 sub-pixels (or pixels)—the width visible being equal to half the width of L2+the width of L3+the width of L4+half the width of L5. By symmetry and similar argument, the width of the display visible to the viewer's right eye 22 is exactly 3 sub-pixels (or pixels) and comprises half the width of the eighth sub-pixel (or pixel)+the width of the ninth sub-pixel (or pixel)+the width of the tenth sub-pixel (or pixel)+half the width of the eleventh sub-pixel (or pixel). For a second given head position which is different to the first head position, a different set of sub-pixels (or pixels) are visible to the viewer's left eye—for example half the width of L1+the width of L2+the width of L3+half the width of L4. By symmetry, the width of the display visible to the viewer's right eye is again exactly 3 sub-pixels (or pixels) and comprises half the width of the seventh sub-pixel (or pixel)+the width of the eighth sub-pixel (or pixel)+the width of the ninth sub-pixel (or pixel) R9+half the width of the tenth sub-pixel (or pixel). Between these head positions is a third head position whereby exactly 3 sub-pixels (or pixels) are visible to the viewer's left eye (L2, L3 and L4) and exactly 3 sub pixels (or pixels) are visible to the viewer's right eye (the eighth, ninth and tenth sub-pixels (or pixels).

The first and second methods have been described above in the context of determining whether a pixel is to be assigned left-eye or right-eye image data in the case of a display having a parallax barrier with fixed positions for the slits or a lenticular array with fixed positions for the lenticular elements. However, a method of the invention may additionally or alternatively be applied to a display having a re-configurable parallax optic, for example a re-configurable parallax barrier in which the position and/or extent of the slits in the barrier are not fixed, and used to calculate optimal barrier parameters for z-tracking based on the distance between the observer and the display. Using independent electrode control, the barrier and slit widths and positions can be varied across the display to give improved performance of a tracked 3D display. Method 1 can be used for example to calculate the affinity of each barrier position (that is, whether the barrier at a particular location should be opaque or not) based on the relative user and display pixel positions. Alternatively, Method 2 could be used for example to dynamically calculate the optimal pitch of the parallax optic and the barrier offset as the user z-position changes. That is, rather than keeping δb fixed so that δa varies as the observer moves, δa would be determined from a desired value of n(repeat), and a value of δb that gives this δa is then determined.

Using either method, the invention offers numerous advantages over previous tracking systems. The primary advantage is the increased z-freedom over fixed-width interlacing systems. A second advantage is ability of the system to work with printed parallax barriers allowing 3D technology to be implemented inexpensively. The lack of moving parts adds the potential for increased robustness and decreased complexity compared with mechanical tracking systems. The ability to change the effective barrier pitch correction gives better off-axis properties, and the ability to dynamically adjust the optimum viewer position to match the user. This allows the display to be re-positioned relative to the user, or even tiled to give a high quality multi-display system.

### EMBODIMENTS

1. In a first embodiment, the tracking system is used in conjunction with a camera and fixed parallax barrier 3D display. Such a system is shown in FIG. 5a. A parallax system with a 6 sub-pixel repeating interlace pattern, a slanted barrier with a slope of 1 pixel per row and a slit width of 3 pixels (NP6-3 stag 1) gives very good tracking performance. This good performance is partly due to the ‘redundant’ sub-pixels that are initially hidden from the user and may be pre-loaded with view information. Correct view information can be maintained for each eye as the user moves and these hidden sub-pixels are revealed. The image processing hardware is configured to implement method one and/or method two as described above.

2. In a second embodiment, the tracking system is used in with a camera and a switchable parallax barrier. The barrier may be switchable in a discrete manner, as illustrated by FIG. 5c, with electrodes used to control spatial transmissivity. The barrier features can then be moved to track the position of the user. Such a parallax barrier may be switched into a transmissive mode so that the full resolution of the base panel is seen in 2D. Such a system may also give brightness advantages over a fixed barrier design. Z tracking can be achieved by changing the display image, changing the width of barrier region and slits across the display (so as to adjust the pitch of the parallax barrier) or a hybrid approach. Possible display constructions that allow for varying barrier pitch are illustrated in FIG. 6a-d. FIGS. 6a and 6b are a plan view and a sectional view of one display that allows for varying barrier pitch. The display has an image display panel in which independently addressable pixels are provided between a TFT substrate and a colour filter substrate—the image display panel may be conventional, and will not be described further. The display also has a parallax barrier panel, in which regions of a medium (for example a liquid crystal or other electro-optic material) disposed between an SEG (“segmented electrode”) substrate and a COM (“common electrode”) substrate may be addressed by means of independently addressable electrodes E(1) . . . E(8) disposed on the SEG substrate and a planar electrode on the COM substrate as shown in FIG. 6(b). The parallax barrier panel and the image display panel are adhered by means of a glue layer, and a polariser may also be provided between the parallax barrier panel and the image display panel. FIG. 6(b) illustrates the electrodes of the parallax barrier panel being addressed such that the regions of the medium opposite electrodes E(1), E(2), and E(6)-E(8) are opaque to define barrier regions while the regions of the medium opposite electrodes E(3)-E(5) are transmissible to define slits. The display of FIGS. 6(c) and 6(d) is generally similar to that of FIGS. 6(a) and 6(b), except that, instead of a planar electrode, individually addressable electrodes E(9)-E (16) are provided on the COM substrate. The electrodes E(9)-E (16) on the COM substrate are offset with respect to the electrodes E(1)-E (8) on the SEG substrate, and this allows finer control of the positions and widths of the barrier regions and slits. (In FIG. 6(d) the COM substrate is not provided with a common electrode per se, but instead is provided with segmented electrodes E(9) . . . E(16), unlike FIG. 6(b) where a single, continuous planar electrode is provided on the COM substrate. However, a skilled person would still regard the COM substrate in FIG. 6(d) as a common electrode substrate, which is a general term in TFT displays.) While FIGS. 6(a-d) illustrate parallax barrier panels with 8 and 16 electrodes, it is possible to construct a parallax barrier with other numbers of electrodes as well.

3. Individual electrodes require more complex control circuitry including more connections, FIG. 7a. As the number of electrodes increases it may become necessary to put control circuitry directly onto the substrate, FIG. 7b, as is currently done with mobile LCD display control systems.

4. In a third embodiment, the tracking system is used with a camera and a parallax barrier that is switchable in a continuous manner.

5. In a fourth embodiment, the system is used with a lens system including lenticular or more sophisticated lens elements. A lenticular lens example is shown in FIG. 5b and in FIG. 8.

6. In a fifth embodiment, the system is used with a MEMS, photochromic, heat-sensitive, bi-stable, GRIN lens or hybrid system . . .

7. In a sixth embodiment, the system is used with a depth sensor being used in place of a camera.

In a method of the first aspect, the determination of the intersection of the ray path and the parallax optic may be based on one or more parameters of the display, and on the relative positions of the observer and the group of pixels. The one or more parameters of the display may comprise a separation between an image display layer of the display and the parallax optic and the ratio between the refractive index of a medium between the image display layer of the display and the parallax optic and the refractive index of a medium between the display and the observer.

A method of the first aspect may comprise determining the intersection according to:

$${b}_{x} = {p}_{x} + \frac{( {e}_{x} - {p}_{x} ) s}{Z α}$$

where bₓ is the x-coordinate of the intersection of the ray path and the parallax optic, pₓ is the x-coordinate of the group of pixels, eₓ is the x-coordinate of the observer's mid-eye position, α is the ratio between the refractive index of a medium between the image display layer of the display and the parallax optic and the refractive index of a medium between the display and the observer, s is the separation between the image display layer of the display and the parallax optic, and Z is the distance between the display and the observer.

In a method of the first aspect determining whether the group of pixels should be addressed with data relating to the first image or to the second image may be based on the distance between the intersection of the ray path and the parallax optic and the nearest aperture of the parallax optic. It may for example comprise determining:

$$χ = \frac{{b}_{x} - nearest slit}{barrier pitch }$$

and determining that the group of pixels should be addressed with data relating to the first image if χ≧0.5, otherwise determining that the group of pixels should be addressed with data relating to the second image.

A method of the first aspect may comprise assigning pre-rendered data values to the pixels. Alternatively, first image data may be rendered for those pixels to be addressed with data relating to the first image, and second image data may be rendered for those pixels to be addressed with data relating to the second image

A method of the first aspect may further comprise determining, from the intersection of the ray path and the parallax optic, a location and size of one or more elements in the parallax optic—for example determining, the location and size of one or more opaque barrier regions in a case where the parallax optic comprises a parallax barrier array. In this embodiment, movement of the observer is compensated for both by re-addressing the image display layer and by re-defining the parallax optic.

In a method of the first or second aspect, the group of pixels may include a single pixel, that is n=1. Alternatively the group of pixels may include two or more pixels, that is n>1.

A method of the third aspect may comprise determining a non-integer pixel interlace value.

A method of the third aspect may comprise determining the pixel interlace value according to

$$n ( repeat ) = \frac{δ a}{2 \times pixel pitch} ,$$

where n(repeat) is the pixel interlace value, δa is the width of the projection of the element of the parallax optic onto the image display layer, and pixel pitch is the pixel pitch of the image display layer of the display.

In a method of the third aspect, the pixel interlace value may be non-integer.

A method of the third aspect may comprise determining the desired projection of the element of the parallax optic according to

$$n ( repeat ) = \frac{δ a}{2 \times pixel pitch} ,$$

where n(repeat) is the pixel interlace value, δa is the width of the projection of the element of the parallax optic onto the image display layer, and pixel pitch is the pixel pitch of the Image display layer of the display.

In a method of the first, second, third or fourth aspect, the first image may be a right eye image and the second image may be a left eye image, whereby the multiple view image is an autostereoscopic 3-D image. Alternatively, the first and second images may be unconnected images for display to different observers.

In a modification of the third embodiment, the optimum barrier position is calculated. This is equivalent to determining a “barrier interlace value” in a manner similar to that described in the third embodiment, and then determining whether a barrier region should be opaque or not in accordance with the value.

A display of the fifth, sixth or seventh aspect may comprise an autostereoscopic display.

The parallax optic of a display of the fifth, sixth or seventh aspect of the invention may be disableable. This allows the display to operate in a conventional 2-D mode. A disableable parallax optic may for example be a parallax barrier aperture array defined in a liquid crystal panel, or a switchable lens array such as a liquid crystal lens array.

### INDUSTRIAL APPLICABILITY

This system could be used to deliver high quality tracked autostereoscopic 3D. Alternatively, it could be used to display different high quality 2D images to multiple viewers.

1. A method of displaying a multiple view image comprising:
for a group of n pixels (n=1, 2, 3 . . . ) of a multiple view directional display, determining, based on the distance between the display and an observer, where a ray path from the group of pixels to the observer intersects a parallax optic of the display;
determining, from the intersection of the ray path and the parallax optic, whether the group of pixels should display a first image or a second image; and
assigning data values to each pixel of the group according to the determination whether the group of pixels should be addressed with data relating to the first image or with data relating to the second image.

2. A method as claimed in claim 1;
wherein the determination of the intersection of the ray path and the parallax optic is based on one or more parameters of the display, and on the relative positions of the observer and the group of pixels;
wherein the one or more parameters of the display comprise a separation between an image display layer of the display and the parallax optic and the ratio between the refractive index of a medium between the image display layer of the display and the parallax optic and the refractive index of a medium between the display and the observer.

3.-4. (canceled)

5. A method as claimed in claim 1 wherein determining whether the group of pixels should be addressed with data relating to the first image or with data relating to the second image is based on the distance between the intersection of the ray path and the parallax optic and the nearest aperture of the parallax optic.

6. (canceled)

7. A method as claimed in claim 1 and comprising the assignment of pre-rendered data values to the pixels.

8. A method as claimed in claim 1 and further comprising determining, from the intersection of the ray path and the parallax optic, a location and size of one or more elements in the parallax optic.

9. A method of displaying a multiple view image comprising:
for a group of n pixels (n=1, 2, 3 . . . ) of a multiple view directional display, determining, based on the distance between the display and an observer, where a ray path from the group of pixels to the observer intersects a re-configurable parallax optic of the display;
determining, from the intersection of the ray path and the re-configurable parallax optic, a desired location and size for one or more elements of the re-configurable parallax optic; and
addressing the re-configurable parallax optic to define one or more elements in the re-configurable parallax optic in accordance with the determined location and size.

10.-11. (canceled)

12. A method of displaying a multiple view image comprising:
determining, based on the distance of an observer from a multiple view directional display having an image display layer and a parallax optic, the width of a projection of the pitch of the parallax optic onto the image display layer;
determining a pixel interlace value from the width of the projection of the pitch of the parallax optic onto the image display layer; and
assigning a pixel with data corresponding to a first image or with data corresponding to a second image in accordance with the determined pixel interlace value.

13. A method as claimed in claim 12 and comprising determining a non-integer pixel interlace value.

14. (canceled)

15. A method of displaying a multiple view image comprising:
determining a desired projection of an element of a re-configurable parallax optic of a multiple view directional display having an image display layer and the re-configurable parallax optic based on a desired pixel interlace value;
determining a desired size for the element of the re-configurable parallax optic, from the desired projection of the element; and
addressing the re-configurable parallax optic to obtain an element of the desired size.

16. A method as claimed in claim 15 and wherein the pixel interlace value is non-integer.

17. (canceled)

18. A method as claimed in claim 15 wherein the first image is a right eye image and the second image is a left eye image, whereby the multiple view image is an autostereoscopic 3-D image

19. (canceled)

20. A multiple view directional display comprising: an image display panel; a re-configurable parallax optic; an observer tracking unit; and a control unit, the control unit adapted to perform a method as defined in claim 15.

21.-23. (canceled)

24. A method as claimed in claim 1 wherein the first image is a right eye image and the second image is a left eye image, whereby the multiple view image is an autostereoscopic 3-D image

25. A multiple view directional display comprising: an image display panel; a parallax optic; an observer tracking unit; and a control unit, the control unit adapted to perform a method as defined in claim 1.

26. A method as claimed in claim 9;
wherein the determination of the intersection of the ray path and the re-configurable parallax optic is based on one or more parameters of the display, and on the relative positions of the observer and the group of pixels;
wherein the one or more parameters of the display comprise a separation between an image display layer of the display and the re-configurable parallax optic and the ratio between the refractive index of a medium between the image display layer of the display and the re-configurable parallax optic and the refractive index of a medium between the display and the observer.

27. A method as claimed in claim 9 and further comprising determining, from the intersection of the ray path and the re-configurable parallax optic, whether the group of pixels should display a first image or a second image.

28. A method as claimed in claim 9 wherein the first image is a right eye image and the second image is a left eye image, whereby the multiple view image is an autostereoscopic 3-D image

29. A multiple view directional display comprising: an image display panel; a re-configurable parallax optic; an observer tracking unit; and a control unit, the control unit adapted to perform a method as defined in claim 9.

30. A method as claimed in claim 12 wherein the first image is a right eye image and the second image is a left eye image, whereby the multiple view image is an autostereoscopic 3-D image

31. A multiple view directional display comprising: an image display panel; a parallax optic; an observer tracking unit; and a control unit, the control unit adapted to perform a method as defined in claim 12.
